(19) United States
(12) Patent Application Publication
(10) Pub. No.: US 2026/0211405 A1
(43) Pub. Date: Jul. 23, 2026

(54) SYSTEMS AND METHODS FOR AI-BASED WIRING INSPECTION

(71) Applicant: OES Inc., London (CA)

(72) Inventors: Carlos Vicente, St. Thomas (CA); Jordan Trachsel, Ingersoll (CA); Reginald Cooper, Red Deer (CA); Mike Nagle, Granton (CA); Albert Francis, London (CA)

(21) Appl. No.: 19/456,698

(22) Filed: Jan. 22, 2026

Related U.S. Application Data
(60) Provisional application No. 63/748,657, filed on Jan. 23, 2025.

(51) Int. Cl. G05B 19/418

(52) U.S. Cl. CPC G05B 19/41875; G05B 2219/32193; G05B 2219/40055

(57) ABSTRACT

A method includes recording at least one image of an end region of a wire after the end region of the wire has been processed by at least one processing stage of a crimping machine; utilizing one or more neural networks to perform an analysis of the at least one image and determine, based on the analysis, whether the end region of the wire exhibits one or more defects; and based on the analysis indicating that the end region of the wire exhibits the one or more defects, performing a remedial action. The remedial action includes at least one of providing a defect notification and instructing the crimping machine to adjust its operation. A wiring inspection system is also disclosed.

### CROSS-REFERENCE TO RELATED APPLICATIONS

This application claims the benefit of U.S. Provisional Application No. 63/748,657, filed on Jan. 23, 2025, the disclosure of which is incorporated herein by reference in its entirety.

### BACKGROUND

This application relates to wiring inspection, and more particularly to systems and methods for artificial intelligence-based wiring inspection.

Various electrical systems, such as vehicle wiring harnesses, may require that a wire is stripped, sealed, and provided with a crimped terminal according to system specifications (e.g., a certain gauge of wire, a certain color of insulation, a certain type of terminal, etc.). For processing of such wires, it is known to use automated and manual wire stripping/sealing/crimping machines, some of which have high outputs (e.g., on the order of multiple crimps per second). Although such machines may be used for limited quantities of wire processing, they are also suitable for high volume processing.

Automated wire crimping machines may include a plurality of stations for processing an incoming wire and outputting a crimped end. Such stations may include, for example, a stripping station for stripping an incoming wire, a sealing station for providing a seal on the wire, and a crimping station for providing a crimped terminal onto the seal and an end region of the wire. The stations may be arranged in a linear fashion, or a circular fashion, for example.

There are various defects that can occur during automated processing, such as wire stripping failures, wire sealing failures, crimping failures, and terminal defects (some of which may be present on a terminal prior to crimping), and identifying those defects presents challenges.

### BRIEF DESCRIPTION OF THE DRAWINGS

A method according to an example embodiment of the present disclosure includes recording at least one image of an end region of a wire after the end region of the wire has been processed by at least one processing stage of a crimping machine; utilizing one or more neural networks to perform an analysis of the at least one image and determine, based on the analysis, whether the end region of the wire exhibits one or more defects; and based on the analysis indicating that the end region of the wire exhibits the one or more defects, performing a remedial action. The remedial action includes at least one of providing a defect notification and instructing the crimping machine to adjust its operation.

In a further embodiment of the foregoing embodiment, the wire is one of a plurality of wires, the method includes repeating the recording and utilizing steps for the plurality of wires, and the performing the remedial action is performed based on occurrence of a predefined quantity of the one or more defects amongst one or more of the plurality of wires.

In a further embodiment of any of the foregoing embodiments, the at least one processing stage includes a plurality of processing stages, and the crimping machine is an automated crimping machine configured to automatically move each of the plurality of wires between each of the plurality of processing stages. The instructing the crimping machine to adjust its operation includes instructing the crimping machine to: cease performance of the plurality of processing stages, initiate a cut sequence that causes the automated crimping machine to clip one of the plurality of wires that exhibits at least one of the one or more defects, or instruct the automated crimping machine to move one of the plurality of wires that exhibits at least one of the one or more defects to a discard area.

In a further embodiment of any of the foregoing embodiments, the at least one processing stage includes a plurality of processing stages. The crimping machine is an automated crimping machine configured to automatically move the plurality of wires between each of the plurality of processing stages. The instructing the crimping machine to adjust its operation includes instructing the crimping machine to reduce a rate at which the automated crimping machine performs the plurality of processing stages.

In a further embodiment of any of the foregoing embodiments, the at least one processing stage includes a plurality of processing stages. The recording is performed such that the at least one image includes respective images of the end region of the wire between each of the plurality of processing stages and also after a final one of the plurality of processing stages. The utilizing the one or more neural networks to perform an analysis of the at least one image includes utilizing the one or more neural networks to perform an analysis of the respective of the end region of each of the plurality of wires between each of the plurality of processing stages and also after the final one of the plurality of processing stages.

In a further embodiment of any of the foregoing embodiments, the at least one processing stage includes a plurality of processing stages, and the method includes utilizing the one or more neural networks to determine which of the plurality of processing stages have been completed for the end region of the wire.

In a further embodiment of any of the foregoing embodiments, the utilizing includes utilizing a first neural network to identify the end region of the wire, a stripped area of the wire, a seal at the end region of the wire, and a crimp terminal at the end region of the wire. The utilizing also includes utilizing a second neural network to determine if the wire exhibits the one or more defects for the stripped area, the seal, or the crimp terminal.

In a further embodiment of any of the foregoing embodiments, the at least one processing stage includes a stripping stage during which at least a portion of the end region of the wire is stripped. For the stripping stage, the one or more defects include one or more of a pulled strand of wire, an incorrect strip length, a wire splay, a partial strip, and an insulation burr.

In a further embodiment of any of the foregoing embodiments, the at least one processing stage includes a sealing stage during which a seal is applied to at least a portion of the end region of the wire. For the sealing stage, the one or more defects include one or more of an incorrect seal position, a lack of a seal, an incorrect seal orientation, and a pierced seal.

In a further embodiment of any of the foregoing embodiments, the at least one processing stage includes a crimping stage during which a crimp terminal is crimped onto at least a portion of the end region of the wire. For the crimping stage, the one or more defects include one or more of a missing crimp terminal, a wire strand being disposed outside the crimp terminal, an incorrect length of exposed wire between a seal and the crimp terminal, and an incorrect length of wire being disposed within the crimp terminal.

A wiring inspection system according to an example embodiment of the present disclosure includes a crimping machine configured to strip, seal, and crimp wires; at least one camera; memory storing one or more neural networks; and processing circuitry. The processing circuitry is configured to use the at least one camera to record at least one image of an end region of a wire after the end region of the wire has been processed by at least one processing stage of the crimping machine; utilize the one or more neural networks to perform an analysis of the at least one image and determine, based on the analysis, whether the end region of the wire exhibits one or more defects; and based on the analysis indicating that the end region of the wire exhibits the one or more defects, perform a remedial action including provision of a defect notification or transmission of an instruction to the crimping machine to adjust its operation.

In a further embodiment of the foregoing embodiment, the wire is one of a plurality of wires. The processing circuitry is configured to perform the following for the plurality of wires: use the at least one camera to record at least one image of an end region of a wire after the end region of the wire has been processed by at least one processing stage of the crimping machine; and utilize the one or more neural networks to perform an analysis of the at least one image and determine, based on the analysis, whether the end region of the wire exhibits one or more defects. The processing circuitry is configured to perform the remedial action based on occurrence of a predefined quantity of the one or more defects amongst one or more of the plurality of wires.

In a further embodiment of any of the foregoing embodiments, the at least one processing stage includes a plurality of processing stages. The crimping machine is an automated crimping machine configured to automatically move each of the plurality of wires between each of the plurality of processing stages. To instruct the crimping machine to adjust its operation, the processing circuitry is configured to instruct the crimping machine to cease performance of the plurality of processing stages, initiate a cut sequence that causes the automated crimping machine to clip one of the plurality of wires that exhibits at least one of the one or more defects, or instruct the automated crimping machine to move one of the plurality of wires that exhibits at least one of the one or more defects to a discard area.

In a further embodiment of any of the foregoing embodiments, the at least one processing stage includes a plurality of processing stages. The crimping machine is an automated crimping machine configured to automatically move the plurality of wires between each of the plurality of processing stages. To instruct the crimping machine to adjust its operation, the processing circuitry is configured to instruct the crimping machine to reduce a rate at which the automated crimping machine performs the plurality of processing stages.

In a further embodiment of any of the foregoing embodiments, the at least one processing stage includes a plurality of processing stages. The processing circuitry is configured to use the camera to record respective images of the end region of the wire between each of the plurality of processing stages and also after a final one of the plurality of processing stages, and utilize the one or more neural networks to perform an analysis of the respective of the end region of each of the plurality of wires between each of the plurality of processing stages and also after the final one of the plurality of processing stages.

In a further embodiment of any of the foregoing embodiments, the at least one processing stage includes a plurality of processing stages, and the processing circuitry is configured to utilize the one or more neural networks to determine which of the plurality of processing stages have been completed for the end region of the wire.

In a further embodiment of any of the foregoing embodiments, the one or more neural networks include a first neural network configured to identify the end region of the wire, a stripped area of the wire, a seal at the end region of the wire, and a crimp terminal at the end region of the wire; and a second neural network configured to determine if the wire exhibits the one or more defects for the stripped area, the seal, or the crimp terminal.

In a further embodiment of any of the foregoing embodiments, the at least one processing stage includes a stripping stage during which at least a portion of the end region of the wire is stripped. For the stripping stage, the one or more defects include one or more of a pulled strand of wire, an incorrect strip length, a wire splay, a partial strip, and an insulation burr.

In a further embodiment of any of the foregoing embodiments, the at least one processing stage includes a sealing stage during which a seal is applied to at least a portion of the end region of the wire. For the sealing stage, the one or more defects include one or more of an incorrect seal position, a lack of a seal, an incorrect seal orientation, and a pierced seal.

In a further embodiment of any of the foregoing embodiments, the at least one processing stage includes a crimping stage, during which a crimp terminal is crimped onto at least a portion of the end region of the wire. For the crimping stage, the one or more defects include one or more of a missing crimp terminal, a wire strand being disposed outside the crimp terminal, an incorrect length of exposed wire between a seal and the crimp terminal, and an incorrect length of wire being disposed within the crimp terminal.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

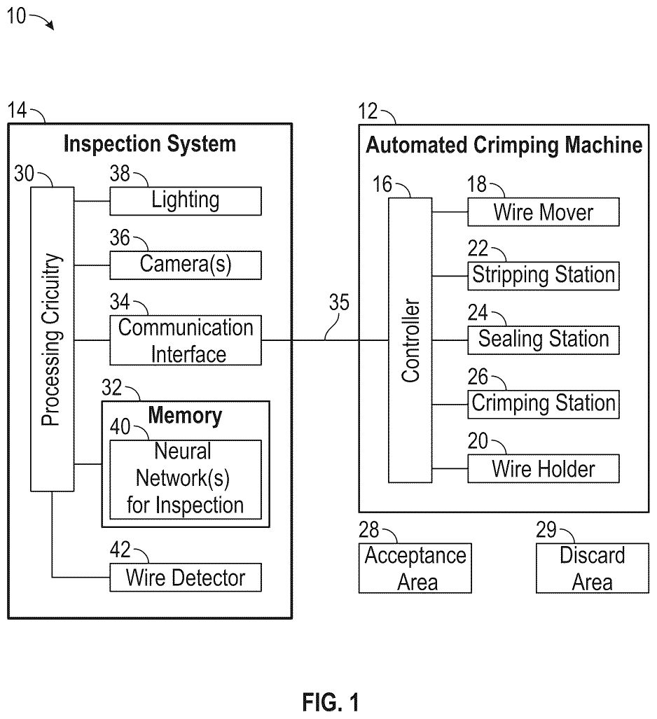

FIG. 1 schematically illustrates a system for automated wire crimping and inspection.

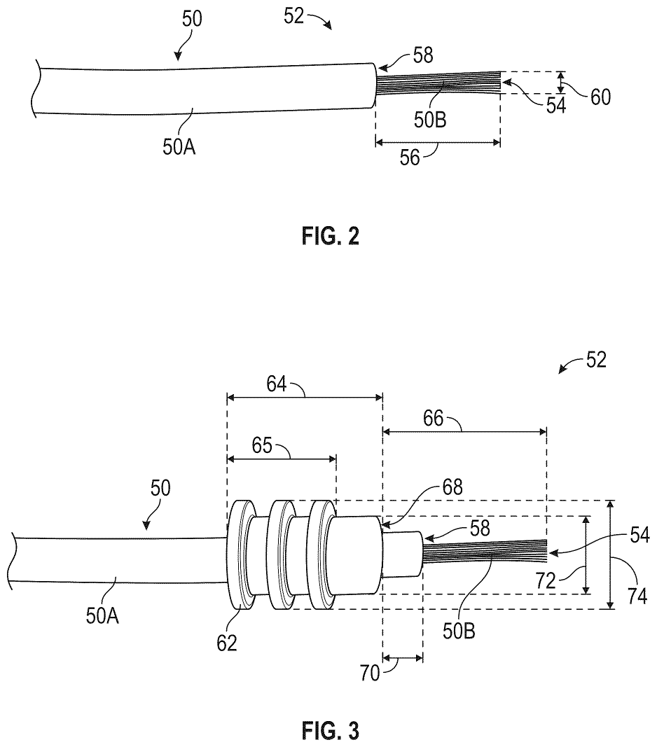

FIG. 2 schematically illustrates a wire that has been processed by a stripping station.

FIG. 3 schematically illustrates an end region of a wire after it has been processed by a sealing station.

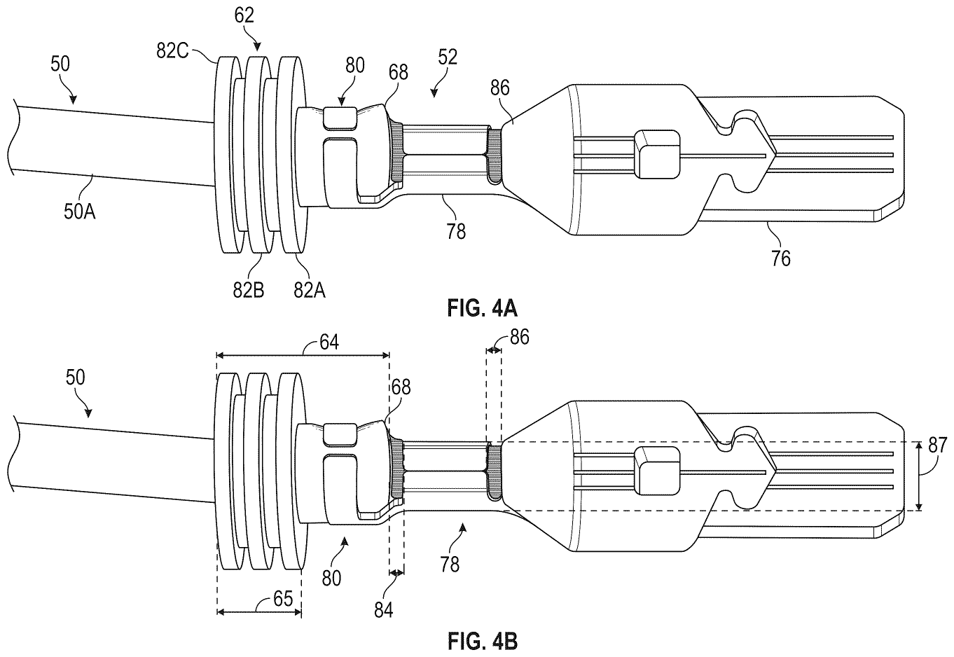

FIG. 4A schematically illustrates the end region of the wire after it has been processed by a crimping station.

FIG. 4B schematically illustrates aspects of the wire of FIG. 4A.

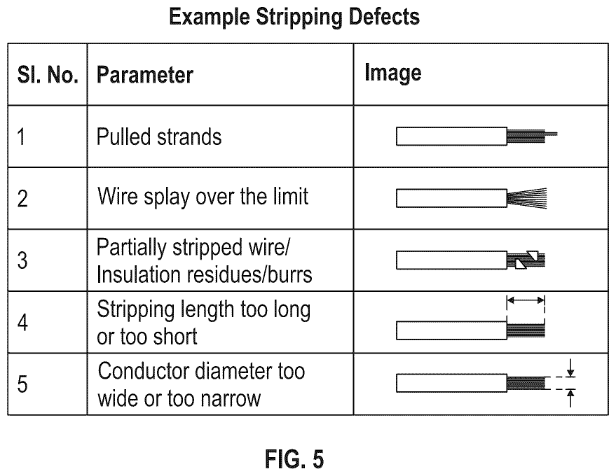

FIG. 5 schematically illustrates a plurality of wire defects that can occur in a stripping stage.

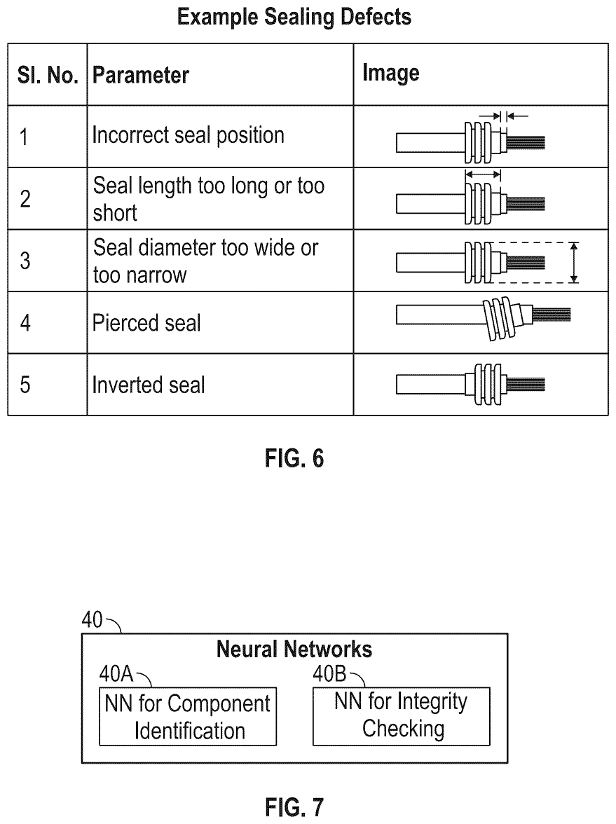

FIG. 6 schematically illustrates a plurality of wire defects that can occur in a sealing stage.

FIG. 7 schematically illustrates a plurality of neural networks that may be used in the system of FIG. 1.

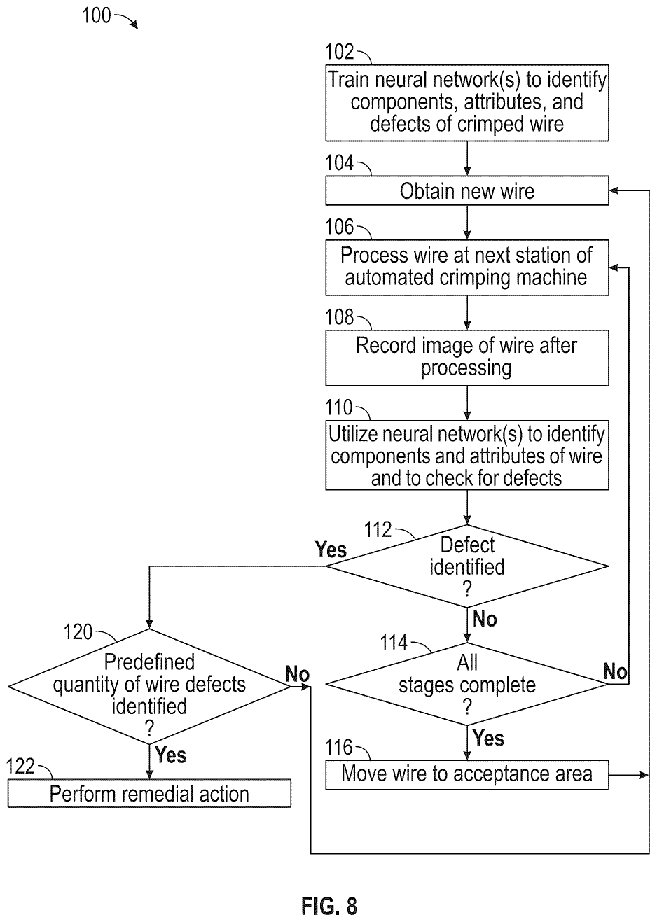

FIG. 8 is a flowchart of an example method for inspecting wire crimping.

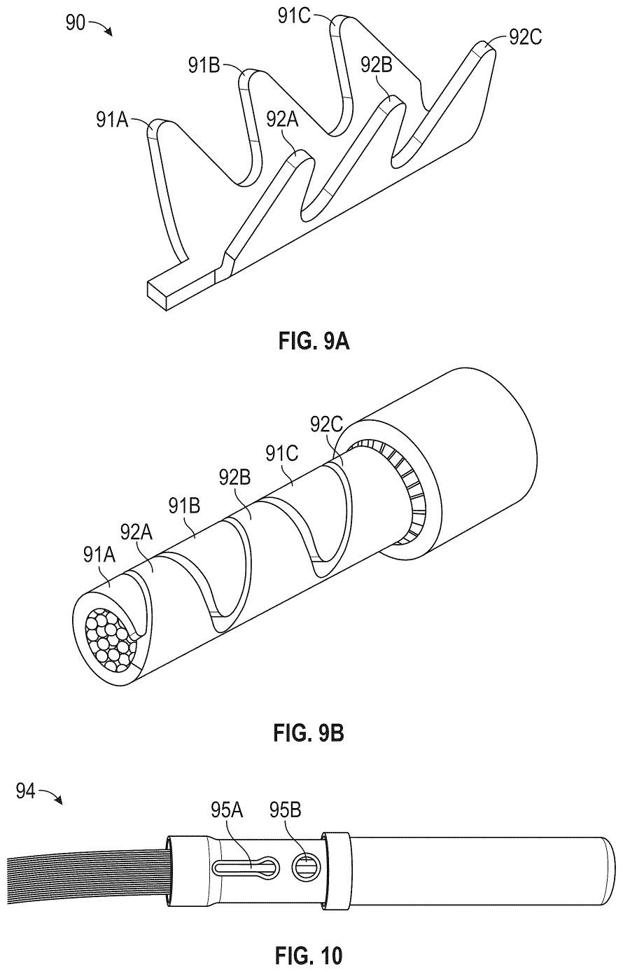

FIG. 9A schematically illustrates an example sharktooth terminal before crimping.

FIG. 9A schematically illustrates the sharktooth terminal of FIG. 9A after crimping.

FIG. 10 schematically illustrates an example indent terminal.

### DETAILED DESCRIPTION

FIG. 1 schematically illustrates an example system 10 for automated wire crimping and inspection. The system 10 includes an example automated crimping machine 12 and an associated example inspection system 14 for inspecting wires at various stages of the crimping process as they are performed by the automated crimping machine 12.

The automated crimping machine 12 includes a controller 16 operatively connected to and configured to control a wire mover 18, a wire holder 20, a stripping station 22, a sealing station 24, and a crimping station 26. The controller 16 includes processing circuitry, such as one or more microprocessors, microcontrollers, application specific integrated circuits (ASICs), or the like. The automated crimping machine 12 may use a linear or a rotary architecture, for example.

Although FIG. 1 depicts an automated crimping machine 12 that includes a wire mover 18 and wire holder 20, it is understood that some automated crimping machines may omit one or both of the wire mover 18 and the wire holder. In one such embodiment, a human operator moves wires between the processing stations 22, 24, and 26. In one embodiment, the crimping machine is non-automated, and a human operator both moves wires between the processing stations 22, 24, and 26 and also performs the processing in each station 22, 24, and/or 26 (e.g., a “bench press”).

The wire mover 18, which may include, e.g., a conveyor belt or a swing arm, is configured to advance wire to a suitable location where it can be gripped by wire holder 20. For example, the wire mover 18 may advance the wire until an end region 52 of the wire 50 (see FIG. 2) is within reach of the wire holder 20. The wire holder 20 is configured to grip the wire 50, and move the wire 50 to the stripping station 22 for a stripping stage (in which at least a portion of the end region 52 is stripped), and then to sealing station 24 for a sealing stage (in which a seal is applied to at least a portion of the end region 52), and then to wire crimping station 26 for a crimping stage (during which a crimp terminal is crimped onto at least a portion of the end region 52), after which the wire 50 may be moved by the wire holder 20 and/or the wire mover 18 to either an acceptance area 28 or a discard area 29, depending on whether any defects are identified.

Each of the stripping station 22, sealing station 24, and crimping station 26 correspond to respective processing stages. In the stripping stage, the stripping station 22 strips at least a portion of the end region 52 of the wire 50 (e.g., i.e., removes an outer insulating layer from the wire). In the sealing stage, the sealing station 24 applies a seal to the wire 50 at the end region 52. In the crimping stage, the crimping station 26 crimps a terminal (e.g., a blade terminal) onto the end of the wire 50. Although only three stations are discussed herein (i.e., stripping station 22, sealing station 24, and crimping station), it is understood that other quantities of stations could be used (e.g., omitting sealing station 24 and/or adding additional stations).

The inspection system 14 includes processing circuitry 30 operatively connector to memory 32, a communication interface, one or more cameras 36 (which may be color cameras), and lighting 38. The processing circuitry 30 may include one or more microprocessors, microcontrollers, application specific integrated circuits (ASICs), or the like. The memory 32 may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The communication interface 34 facilitates communication (e.g., the transmission of commands, and/or other analog/digital interface signals) between the processing circuitry 30 and controller 16 through a connection 35, which may be wired or wireless connection.

The one or more cameras 36 are configured to record images of the end region 52 of a plurality of wires 50 as the wires 50 are advanced through the plurality of processing stages corresponding to the processing stations 22, 24, 26. In one or more embodiments, multiple cameras 36 are provided (e.g., one for each of stripping station 22, sealing station 24, and crimping station 26). In one or more embodiments, a single camera is used for all three stations 22, 24, 26, and the wire mover 18 and/or wire holder 20 (or a human operator) move the wire 50 into the field of view of the single camera after processing by each station 22, 24, 26.

Lighting 38 (e.g., LED lighting) is configured to provide light for the camera(s) 36 to record the images. In one or more embodiments, the processing circuitry 30 is configured to turn the lighting 38 off between photographs, even where multiple photographs are performed per second, in order to reduce power consumption. Alternatively, the lighting 38 could be kept turned on between photographs.

The memory 32 includes one or more neural networks 40. The processing circuitry 30 is configured to utilize artificial intelligence and machine learning for inspecting the wire (in particular the end region 52 of the wire 50) and determining whether the end region 52 exhibits any defects. This may be performed after completion of all stages, or may be performed after individual ones of the stages (e.g., one image for each stage before the next stage is initiated). This will be discussed in greater detail below. The memory 32 may also store a repository of images (e.g., color images) from the camera(s) 36 of analyzed wires, which may be useful in the event there is a recall and it would be desirable to identify a specific batch of wires that were previously analyzed.

In one or more embodiments, if the processing circuitry 30 deems a wire to be defective (e.g., defectively stripped, sealed, and/or crimped), the processing circuitry 30 provides a notification (which may include a defect command) to the controller 16, and based on this the controller 16 utilizes the wire mover 18 and/or wire holder 20 move the defective wire to the discard area 29, which may include a chopper for destroying the wire. On the contrary, if the processing circuitry 30 deems a wire to be acceptable, the wire mover 18 and/or wire holder 20 move the acceptable wire to the acceptance area 28. In one or more embodiments, the controller 16 assumes a wire 50 is acceptable unless a defect notification is received.

A wire detector 42 may be provided which is configured to detect the presence of a wire, and may be used to determine when a wire should be photographed. Some example types of wire detectors include cameras (where a wire would be detected through image analysis), lasers (where beam interruption would indicate wire presence), or a switch (which may be actuated by the presence of a wire).

FIG. 2 schematically illustrates an example of a wire 50 that has been stripped by the stripping station 22. It is understood that depicted wire 50 is a non-limiting example, and that different wires of different thicknesses could be used. The wire 50 includes an insulated portion 50A that has not been stripped, and a stripped portion 50B that has been stripped. The wire 50 has an end region 52 that terminates at an end 54, and the stripped portion 50B is part of the end region 52. Some example characteristics of the wire 50 that may be analyzed for the stripping stage include a length 56 of the stripped portion 50B (with the length spanning between the end 54 of the wire 50 and an end 58 of an insulating layer of the wire 50), and a splay width 60 corresponding to a width of the stripped portion 50B.

In one or more embodiments, the end region 52 corresponds to the last 1 inch of the wire 50. In one or more further embodiments, the end region 52 corresponds to the last 2 inches of the wire 50. In one or more further embodiments, the end region corresponds to the last 3 inches of the wire.

FIG. 3 schematically illustrates an example of the end region 52 of the wire 50 after it has been processed by the sealing station 24 such that a seal member 62 has been placed around the insulated portion 50A of the wire, at a location shown in FIGS. 4A-B that is also part of the end region 52.

Some characteristics of the wire 50 that may be analyzed for the sealing stage include a seal width 64, a seal rib width 65 corresponding to a width of the seal member 62 that includes ribs 82A-C (see FIG. 4A), a seal position 66 (corresponding to a distance between the end 54 and a front end 68 of the seal member 62), a strip-to-seal distance 70 (corresponding to a distance between the end 68 of the seal member 62 and the end 58 of the insulated portion 50A), a minimum seal height/outer diameter 72, and a maximum seal height/outer diameter 74.

FIG. 4A schematically illustrates an example of the end region 52 of the wire 50 after it has been processed by the crimping station 26 to have a terminal 76 (or “crimp terminal”) crimped onto the end region 52. As shown, the terminal 76 has been crimped onto the stripped portion 50B of the wire (see first crimp 78, which is a “conductor crimp”), and has also been crimped onto the seal member 62 (see second crimp 80, also known as a “bellmouth crimp” or “jacket crimp”). As shown, the seal member 62 includes a first rib 82A, second rib 82B, and a third rib 82C. Although the terminal 76 is a blade terminal in FIG. 4A, it is understood that this is a non-limiting type of terminal, and that other types of terminals could be used (such as shark tooth terminals, c-crimp terminals, b-crimp terminals, overlap crimp terminals, f-crimp terminals, indent terminals, open barrel terminals, closed barrel terminals, and various implementations of each).

FIG. 4B schematically illustrates example aspects of the crimped wire 50 that may be analyzed after the crimping stage. These include the seal width 64, the seal rib width 65, a conductor visibility length 84 (corresponding to how much of the stripped portion 50B is provided between the end 68 of the insulated portion and the second crimp 80), a brush length 86 (corresponding to a length of exposed area of the stripped portion 50B adjacent to the first crimp 78), the minimum seal height/diameter 72 (see FIG. 3) after crimping, the maximum seal height/diameter 74 (see FIG. 3) after crimping, and a width 87 between a center of second crimp 80 and an outer boundary of the second crimp 80.

FIG. 5 schematically illustrates a plurality of defects that may occur in the stripping stage corresponding to stripping station 22, such as pulled strands, wire splaying over a limit, partial stripping, etc.

FIG. 6 schematically illustrates a plurality of defects that may occur in the sealing stage corresponding to sealing station 24, such as incorrect seal position, incorrect seal length, incorrect seal diameter, etc.

There are various defects that may occur during the crimping stage, or that may be exhibited by a terminal which is being crimped onto the wire even before the crimping has occurred. Some non-limiting examples of crimping/terminal defects include the following:
shape of a crimp;
integrity of a crimp (e.g., does the crimp have an acceptable appearance/profile);
dented terminal;
terminal with insufficient tin plating;
terminal composed of or plated with an incorrect finish and/or metal (e.g., it is rusty, or does it use nickel instead of brass);
terminal with a crooked stabilizer;
terminal plating is missing;
terminal with incorrect texture, color, and/or luster (e.g., too shiny, too matte, too dull);
insulator claw being crooked, open, misaligned, and/or uncoursed;
terminal with a burr;
rusty terminal;
a terminal that is crooked and/or misaligned; and
a crimp with no wire strands within the crimp.

As discussed above and as depicted in the various examples of FIGS. 5-6, there are a wide variety of defects that may occur.

Referring again to FIG. 1, the processing circuitry 30 is configured to utilize a machine learning algorithm and artificial intelligence, which includes the one or more neural networks 40, to analyze images of wires and determine if they exhibit defects.

FIG. 7 schematically illustrates a plurality of neural networks that may be used in the system of FIG. 1. As shown, the one or more neural networks 40 for inspection of wire crimping may include a first neural network 40A for component and attribute identification (e.g., for identification of the end region 52 of the wire 50, a stripped area of the wire 50, a seal at the end region of the wire 50, and a crimp terminal at the end region 52), and a second neural network 40B for integrity checking/defect detection (e.g., for the stripped area, the seal, or the crimp terminal).

In one or more embodiments, the first neural network 40A is trained based on training data (e.g., labeled training data) to identify the various components/analysis areas involved in wire crimping, such as the following: insulated portion 50A of the wire 50, stripped portion 50B of the wire 50, end 58 of the insulated portion 50A of the wire, seal member 62, terminal 76, first crimp 78, and second crimp 80. The first neural network 40A may be pre-trained (prior to performing the method of FIG. 8) or may be trained in real-time based on known examples of a properly crimped wire. The pre-training may be based on a single sample to which all other samples are compared, for example. The pre-training may be based on multiple samples each with discrete correct areas (e.g., correct strip, correct seal, correct crimp).

The first neural network 40A may be further trained to identify the relevant attributes, such as lengths and widths, discussed above, such as: seal width 64, seal rib width 65, seal position 66, strip-to-seal distance 70, minimum seal height/diameter 72, maximum seal height/diameter 74, brush length 86, conductor visibility length 84, and width 87. In one or more embodiments, the first neural network 40A may be used to detect text stamped onto a terminal and/or the color of stripes on a wire.

In one or more embodiments, the second neural network 40B is trained to identify the some or all of the defects described above in connection with the processing stages 22, 24, 26. Images, such as those shown in FIGS. 5-6 may be used as training data for the training of the second neural network 40B.

FIG. 8 is a flowchart of an example method 100 for inspecting a wire 50. Neural network(s) 40 are trained to identify relevant components, areas, and defects of a wire 50 throughout a crimping process (step 102). As described above, this may include training neural network 40A for component and area identification, and training neural network 40B for integrity checking/defect detection. Also, as discussed above the training may occur prior to performance of the method 100 (pre-training) or may be performed in real-time as the method 100 is performed. FIG. 8 assumes that the automated crimping machine 12 of FIG. 1 is used, but it is understood that the same inspection techniques could also be used for partially automated or non-automated crimping machines, as discussed above.

The automated crimping machine 12 obtains a new wire (step 104), which may involve use of wire mover 18 and/or wire holder 20. In one or more embodiments, step 104 is initiated and/or controlled by the inspection system 14 through connection 35.

The automated crimping machine 12 processes the wire 50 at its next station (step 106), which in the example of FIG. 1 starts with the stripping station 22. The one or more cameras 36 record one or more images of the wire 50 after processing by the station (step 108). As discussed above, the wire detector 42 may be used to determine when to record the image(s) in step 108. In one or more embodiments, the images recorded by the camera(s) 36 are initially stored in a buffer in the memory 32 while they await processing.

The processing circuitry 30 utilizes the neural network(s) 40 to identify the various components/attributes of the wire 50 and to check for defects (step 110). The identification portion of step 110 may include categorizing analysis areas (or “blobs”) of the wire (e.g., insulated portion 50A, stripped portion 50B, seal member 62, and terminal 76, etc.). However, it is understood that these are non-limiting examples, and that other blobs may be used.

In one or more embodiments, in step 110 the neural network(s) 40 are used to identify finite measurements (e.g., the various lengths/widths discussed above) and to compare those to thresholds to check for defects. In one or more embodiments, in addition to or as an alternative to numerical comparisons, the one or more neural network(s) 40 are used to perform comparative based inspections based on the appearance of various defects (e.g., does a particular length or width look too long based on image comparison).

The outcome of the image analysis of step 110 may be either a “pass” or a “fail” output, for example, and may optionally also include a defect identification/description. The defect identification may include an indication for a severity of the defect in one or more embodiments. The severity may indicate how much of a deviation a sample is from an acceptable standard, as the acceptability criteria may vary for different users (e.g., for a first customer a 93% match to a non-defect image may be acceptable, and a 91% match may not, whereas for another customer a 99% non-defect may be required).

A determination is made of whether a wire defect is identified (step 112) (e.g., for the stripped area, the seal, or the crimp, such as any of the defects discussed above). If no defect is identified (a “no” to step 112), and all processing stages are not complete yet for the wire (a “no” to step 114), then steps 106-114 are repeated for the remaining stations. Thus, steps 106-114 are performed for the sealing station 24 and are then performed for the crimping station 26. Once all processing stages are complete (a “yes” to step 114), the wire 50 is moved to the acceptance area 28 (step 116), and the method proceeds to step 104 to obtain a new wire for processing.

However, if a defect is identified for one of the processing stages (a “yes” to step 112), the processing circuitry 30 determines whether a predefined quantity of wire defects have been identified amongst one or more of a plurality of wires 50 (step 120). In one or more embodiments, the predefined quantity of wire defects also has a requirement that the defects occur across a predefined quantity of wires. In one or more embodiments, the predefined quantity is one. In one or more further embodiments, predefined quantity is greater than one (e.g., X number of wire defects have been detected for Y wires). In one or more embodiments, the outcome of step 120 is only a “yes” if the predefined quantity of wire defects have a corresponding defect severity that is above a predefined severity threshold (see discussion above). The predefined quantity of wire defects may be one, or may be more than one.

If the predefined quantity of wire defects has not yet been identified (a “no” to step 120), the method 100 proceeds back to step 104 to obtain a new wire for processing. However, if the predefined quantity of wire defects is identified (a “yes” to step 120), the processing circuitry 30 performs a remedial action (step 122).

The remedial action of step 122 may include one or any combination of the following, for example:
instructing the automated crimping machine to cease operation (i.e., of the plurality of processing steps);
instructing the automated crimping machine to slow down operation so that the plurality of processing steps are performed more slowly;
instructing the automated crimping machine to move a defective wire 50 to the discard area 29;
instructing the automated crimping machine to initiate a cut sequence that causes the automated crimping machine to clip one of the plurality of wires that exhibits a defect; or
providing a defect notification corresponding to or any combination of:
   flagging a fail count (e.g., in a log file)
   signaling to an operator of a failed processing step (e.g., sound, light, or both);
   transmitting a fault notification message.

The defect notification may be provided to a human operator of the crimping machine in embodiments utilizing a non-automated crimping machine, for example and/or to a server. The notification may be provided to a supervisor of the automated crimping machine 12, and may include a visual and/or auditory notification, for example. In one or more embodiments, the notification is provided to the controller 16, and the controller 16 gets to decide how to respond (e.g., emit audible sound, provide visual notification, and/or move part to discard area 29). In one or more embodiments, the notification includes storing an indication of the defective wire in a log file.

Although FIG. 8 describes an embodiment in which inspection is performed after each stage of processing, it is understood that inspection may be omitted for one or more stages (e.g., inspect after stripping stage, skip inspection after sealing stage, and then inspect after crimping stage). In such an embodiment, the final inspection (e.g., post-crimping stage) may still be able to inspect the seal member 62 to some extent even without an inspection between the sealing stage and the crimping stage.

FIG. 9A schematically illustrates an example sharktooth terminal 90 before crimping. This is one of many types of unique terminals that may be used besides the standard terminals depicted in the preceding figures. As shown, the sharktooth terminal includes first teeth 91A-C and second teeth 92A-C, which when crimped interlock with each other (see FIG. 9B).

FIG. 10 schematically illustrates an example of an indent terminal 94 which includes a first opening 95A and a second opening 95B. At least the second opening 95B serves as an inspection hole for viewing wire strands within the terminal 94. In one or more embodiments, the inspection system analyses images depicting one or both of the openings 95A-B to look for wiring defects.

The systems and methods discussed herein combine AI recognition with machine learning, and in one or more embodiments allow the inspection system 14 to create analysis parameters for new combinations that have not been included in the original learned data.

A large variety of metal materials can be bent and shaped into wires, and virtually any wire can be crimped. From automotive and aerospace to healthcare and defense, the crimping of wires is a standard manufacturing process and spans various industries. Achieving a quality crimp is important, as even the smallest of defects may impact the reliability of the terminal and wire connections. The systems and methods discussed herein are widely adaptable to many different types of wires and crimps.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A method, comprising:
recording at least one image of an end region of a wire after the end region of the wire has been processed by at least one processing stage of a crimping machine;
utilizing one or more neural networks to perform an analysis of the at least one image and determine, based on the analysis, whether the end region of the wire exhibits one or more defects; and
based on the analysis indicating that the end region of the wire exhibits the one or more defects, performing a remedial action;
wherein the remedial action comprises at least one of providing a defect notification and instructing the crimping machine to adjust its operation.

2. The method of claim 1, wherein:
the wire is one of a plurality of wires;
the method includes repeating said recording and utilizing steps for the plurality of wires; and
said performing the remedial action is performed based on occurrence of a predefined quantity of the one or more defects amongst one or more of the plurality of wires.

3. The method of claim 2, wherein:
the at least one processing stage includes a plurality of processing stages;
the crimping machine is an automated crimping machine configured to automatically move each of the plurality of wires between each of the plurality of processing stages; and
said instructing the crimping machine to adjust its operation comprises instructing the crimping machine to:
cease performance of the plurality of processing stages;
initiate a cut sequence that causes the automated crimping machine to clip one of the plurality of wires that exhibits at least one of the one or more defects; or
instruct the automated crimping machine to move one of the plurality of wires that exhibits at least one of the one or more defects to a discard area.

4. The method of claim 2, wherein:
the at least one processing stage includes a plurality of processing stages;
the crimping machine is an automated crimping machine configured to automatically move the plurality of wires between each of the plurality of processing stages; and
said instructing the crimping machine to adjust its operation comprises instructing the crimping machine to reduce a rate at which the automated crimping machine performs the plurality of processing stages.

5. The method of claim 2, wherein:
the at least one processing stage includes a plurality of processing stages;
said recording is performed such that the at least one image includes respective images of the end region of the wire between each of the plurality of processing stages and also after a final one of the plurality of processing stages; and
said utilizing the one or more neural networks to perform an analysis of the at least one image comprises utilizing the one or more neural networks to perform an analysis of the respective of the end region of each of the plurality of wires between each of the plurality of processing stages and also after the final one of the plurality of processing stages.

6. The method of claim 1, wherein:
the at least one processing stage includes a plurality of processing stages; and
the method comprises utilizing the one or more neural networks to determine which of the plurality of processing stages have been completed for the end region of the wire.

7. The method of claim 1, wherein said utilizing comprises:
utilizing a first neural network to identify the end region of the wire, a stripped area of the wire, a seal at the end region of the wire, and a crimp terminal at the end region of the wire; and
utilizing a second neural network to determine if the wire exhibits the one or more defects for the stripped area, the seal, or the crimp terminal.

8. The method of claim 1, wherein:
the at least one processing stage includes a stripping stage during which at least a portion of the end region of the wire is stripped; and
for the stripping stage, the one or more defects include one or more of:
a pulled strand of wire;
an incorrect strip length;
a wire splay;
a partial strip; and
an insulation burr.

9. The method of claim 1, wherein:
the at least one processing stage includes a sealing stage during which a seal is applied to at least a portion of the end region of the wire; and
for the sealing stage, the one or more defects include one or more of:
an incorrect seal position;
a lack of a seal;
an incorrect seal orientation; and
a pierced seal.

10. The method of claim 1, wherein:
the at least one processing stage includes a crimping stage during which a crimp terminal is crimped onto at least a portion of the end region of the wire; and
for the crimping stage, the one or more defects include one or more of:
a missing crimp terminal;
a wire strand being disposed outside the crimp terminal;
an incorrect length of exposed wire between a seal and the crimp terminal; and
an incorrect length of wire being disposed within the crimp terminal.

11. A wiring inspection system, comprising:
a crimping machine configured to strip, seal, and crimp wires;
at least one camera;
memory storing one or more neural networks; and
processing circuitry configured to:
use the at least one camera to record at least one image of an end region of a wire after the end region of the wire has been processed by at least one processing stage of the crimping machine;
utilize the one or more neural networks to perform an analysis of the at least one image and determine, based on the analysis, whether the end region of the wire exhibits one or more defects; and
based on the analysis indicating that the end region of the wire exhibits the one or more defects, perform a remedial action comprising provision of a defect notification or transmission of an instruction to the crimping machine to adjust its operation.

12. The wiring inspection system of claim 11, wherein:
the wire is one of a plurality of wires;
the processing circuitry is configured to perform the following for the plurality of wires:
use the at least one camera to record at least one image of an end region of a wire after the end region of the wire has been processed by at least one processing stage of the crimping machine; and
utilize the one or more neural networks to perform an analysis of the at least one image and determine, based on the analysis, whether the end region of the wire exhibits one or more defects; and
the processing circuitry is configured to perform the remedial action based on occurrence of a predefined quantity of the one or more defects amongst one or more of the plurality of wires.

13. The wiring inspection system of claim 12, wherein:
the at least one processing stage includes a plurality of processing stages;
the crimping machine is an automated crimping machine configured to automatically move each of the plurality of wires between each of the plurality of processing stages; and
to instruct the crimping machine to adjust its operation, the processing circuitry is configured to instruct the crimping machine to:
cease performance of the plurality of processing stages;
initiate a cut sequence that causes the automated crimping machine to clip one of the plurality of wires that exhibits at least one of the one or more defects; or
instruct the automated crimping machine to move one of the plurality of wires that exhibits at least one of the one or more defects to a discard area.

14. The wiring inspection system of claim 12, wherein:
the at least one processing stage includes a plurality of processing stages;
the crimping machine is an automated crimping machine configured to automatically move the plurality of wires between each of the plurality of processing stages; and
to instruct the crimping machine to adjust its operation, the processing circuitry is configured to instruct the crimping machine to reduce a rate at which the automated crimping machine performs the plurality of processing stages.

15. The wiring inspection system of claim 12, wherein:
the at least one processing stage includes a plurality of processing stages; and
the processing circuitry is configured to:
use the camera to record respective images of the end region of the wire between each of the plurality of processing stages and also after a final one of the plurality of processing stages; and
utilize the one or more neural networks to perform an analysis of the respective of the end region of each of the plurality of wires between each of the plurality of processing stages and also after the final one of the plurality of processing stages.

16. The wiring inspection system of claim 12, wherein:
the at least one processing stage includes a plurality of processing stages; and
the processing circuitry is configured to utilize the one or more neural networks to determine which of the plurality of processing stages have been completed for the end region of the wire.

17. The wiring inspection system of claim 11, wherein the one or more neural networks comprise:
a first neural network configured to identify the end region of the wire, a stripped area of the wire, a seal at the end region of the wire, and a crimp terminal at the end region of the wire; and
a second neural network configured to determine if the wire exhibits the one or more defects for the stripped area, the seal, or the crimp terminal.

18. The wiring inspection system of claim 11, wherein:
the at least one processing stage includes a stripping stage during which at least a portion of the end region of the wire is stripped; and
for the stripping stage, the one or more defects include one or more of:
a pulled strand of wire;
an incorrect strip length;
a wire splay;
a partial strip; and
an insulation burr.

19. The wiring inspection system of claim 11, wherein:
the at least one processing stage includes a sealing stage during which a seal is applied to at least a portion of the end region of the wire; and
for the sealing stage, the one or more defects include one or more of:
an incorrect seal position;
a lack of a seal;
an incorrect seal orientation; and
a pierced seal.

20. The wiring inspection system of claim 11, wherein:
the at least one processing stage includes a crimping stage, during which a crimp terminal is crimped onto at least a portion of the end region of the wire; and
for the crimping stage, the one or more defects include one or more of:
a missing crimp terminal;
a wire strand being disposed outside the crimp terminal;
an incorrect length of exposed wire between a seal and the crimp terminal; and
an incorrect length of wire being disposed within the crimp terminal.
